(19) United States
(12) Patent Application Publication
(10) Pub. No.: US 2011/0138475 A1
(43) Pub. Date: Jun. 9, 2011

(54) SYSTEMS AND METHOD FOR PROVIDING TRUSTED SYSTEM FUNCTIONALITIES IN A CLUSTER BASED SYSTEM

(75) Inventors: David Gordon, Montreal (CA); András Méhes, Solna (SE); Makan Pourzandi, Montreal (CA)

(73) Assignee: TELEFONAKTIEBOLAGET L M ERICSSON (PUBL), Stockholm (SE)

(21) Appl. No.: 13/056,750

(22) PCT Filed: Jul. 30, 2008
(86) PCT No.: PCT/IB08/53050

§ 371 Date: Feb. 10, 2011

(51) Int. Cl. G06F 21/00

(52) U.S. Cl. 726/26

(57) ABSTRACT

A framework for providing cluster-wide cryptographic operations, including: signing, sealing, binding, unsealing, and unbinding. The framework includes an interface module (a.k.a., HAT agent) on each of a plurality of nodes in the cluster. Each HAT agent is configured to respond to an application's request for a cluster crypto operation by communication with other HAT agents in the cluster and utilizing a trusted platform module local to the node where the HAT agent resides.

### TECHNICAL FIELD

The present invention relates to the field of trusted systems.

### BACKGROUND

As the Trusted Computing Group's (TCG's) Trusted Platform Module (TPM) is on its way to becoming widely used, there is an increasing interest in utilizing this technology in different contexts, including clusters for high-availability (HA) computing.

HA clusters have special needs for robust distributed processing, coordination, replication, failover, etc., which needs are not specifically addressed by the TCG's specifications. More specifically, there seems to be an emergence of two types of clustering hardware, namely the multi-core chip and clusters of mezzanine cards. It is conceivable that in the future, mezzanine cards will be equipped with TPMs for security reasons. However, there are currently no functionalities that would allow multiple mezzanine TPMs in the same cluster to function together. In the same line of thought, the TCG specification does not support current HA functionality such as transparent fail-over. That is, there is no solution to provide TPM functionality in HA clusters.

Thus, there exists a need to overcome at least some of the above described disadvantages.

### SUMMARY

Aspects of the present invention provide systems and methods for providing trusted system functionalities in a cluster based system. For example, in one aspect, the invention provides a method for performing a security operation on data D in an environment comprising a cluster of nodes, wherein each of a plurality of nodes in the cluster contains a share of a cluster key. In one embodiment, the method includes: requesting from a first node that each of the plurality of nodes in the cluster perform a part of the security operation on D; receiving, from each of at least a threshold number of nodes from the plurality of nodes, a partial result of the security operation; obtaining a local share of the cluster key using a trusted platform module (TPM) in the first node; using the obtained local share of the cluster key to perform a local part of the security operation on D, thereby producing a local result; and combining the local result with the received partial results to produce a final result. The step of obtaining the local share may comprise using TPM software to obtain the local share from a storage unit in the TPM and/or retrieving an encrypted version of the share and decrypting the encrypted version of the share to retrieve the share. The step of decrypting the share may include using the TPM to decrypt the share. In some embodiments, the TPM comprises a microcontroller with cryptographic functionalities. The security operation may be any one of the following operations: binding data, unbinding data, sealing data, unsealing data, and signing data.

In some embodiments, the method also includes the step of receiving from an application executing on the first node a request to perform the security operation on data D using the cluster key, wherein the step of receiving the request from the application occurs prior to the step of requesting from the first node that each of the plurality of nodes in the cluster perform a part of the security operation on D.

In some embodiments, the step of requesting from the first node that each of the plurality of nodes in the cluster perform a part of the security operation on D includes sending from the first node to each of the plurality of nodes in the cluster the data D. Preferably, each of the plurality of nodes in the cluster is configured to perform the part of the security operation on D by utilizing a TPM installed in the node.

In another aspect, the invention provides a method of enabling trusted platform module functionality to a cluster comprising a set of nodes, wherein each node comprises an agent, a trusted platform module (TPM) and TPM software for accessing functions of the TPM. In some embodiments, the method includes: creating a cluster key; and storing in each node included in the set of nodes a share of the cluster key, wherein the agent is operable to receive an application request, and is configured to (1) use at least some of the TPM software in response to receiving the application request and (2) transmit a request to a plurality of other agents in response to receiving the request. For each node in the set, the method may also include (a) storing the share provided to the node in the TPM and/or (b) encrypting the share provided to the node using the TPM and TPM software. Preferably, the TPM software includes a TPM device driver, a device driver library, a core services, and a service provider. The agent may receive the application request directly from an application or from the service provider, and the application request is a request to perform a security operation using data, the security operation including any one of binding the data, unbinding the data, sealing the data, unsealing the data, and signing the data.

When the application request is a request to sign data, the agent sends the data to each of a plurality of nodes in the cluster and requesting that each node sign the data using their share of the cluster key; receives, from each of the plurality of nodes, a result of the performed security operation; obtains its own share of the cluster key; uses the obtained share of the cluster key to sign the data, thereby producing a local result; and combines the local result with the received results to produce a final result. In some embodiments, each node included in the set of nodes generates a share of the cluster key or a share is provided to each node.

In another aspect, the invention provides a method of sealing data to a configuration of a cluster comprising a set of two or more nodes. In some embodiments, the method includes: storing a cluster configuration value in each node included in the set; using an agent executing on one of the nodes in the set to modify the cluster configuration value, wherein the modified cluster configuration value represents a particular configuration of the cluster; transmitting, from the agent to a plurality of other agents, each of which executes on a different one of the nodes in the set, the modified cluster configuration value, wherein the agent uses the modified cluster configuration value and a share of a cluster key to seal the data to the particular cluster configuration. Preferably, each node in the set comprises a trusted platform module (TPM) and TPM software for accessing functions of the TPM.

In some embodiments, the step of using the modified cluster configuration value and a share of a cluster key to seal data to the particular cluster configuration includes: (1) transmitting a message from the agent to the plurality of other agents, the message comprising the data and requesting that each of the plurality of other agents perform a security operation on the data; (2) receiving from each of the plurality of other agents a result of the security operation; (3) obtaining a share of the cluster key; (4) using the obtained share of the cluster key and the particular cluster configuration value to perform a security operation on the data, thereby producing a local result; and (5) combining the local result with the received results.

In another aspect, the invention provides an improved cluster. In some embodiments, each of a plurality of nodes of the cluster includes: a trusted platform module (TPM); TPM software for accessing functions of the TPM; a share of a cluster key; and an agent operable to receive a request to perform an operation. The agent is configured to perform steps (1) and (2) in response to receiving the request to perform the operation: (1) performing the operation using the TPM software; and (2) transmitting to a plurality of other agents a request to perform the operation, wherein each other agent resides on a different one of the plurality of nodes. Preferably, each of the plurality of nodes includes a storage unit storing a cluster configuration value representing a particular configuration of the cluster, wherein the cluster configuration value is used to seal data to the particular cluster configuration.

In another aspect, the invention provides an agent for extending trusted platform module functionality to a plurality of nodes in a cluster. In some embodiments, the agent includes: a receiving module for receiving a request sent from an application to perform a security operation; a module for using TPM software and a share of a cluster key to perform the security operation, thereby producing a local result, in response to receiving the application request to perform the security operation; a transmit module for transmitting to a plurality of other agents a request to perform the security operation in response to receiving the application request to perform the security operation; a result receiving module for receiving from each of the plurality of other agents a result of the security operation; and a combining module for combining the received results with the local result to produce a final result. The agent may also includes a share retrieving module that retrieves the share, a share storing module that stores the share, a valid cluster configuration determining module that determines whether a cluster configuration value is valid, a cluster configuration value retrieving module that retrieves a cluster configuration value, a timed-out determining module that determines whether an operation has timed-out, and/or a cluster configuration value updating module that updates a cluster configuration value.

In another aspect, the invention provides a system for extending trusted platform module functionality to a plurality of nodes in a cluster. In some embodiments, the system includes: a plurality of nodes within a cluster; a cluster managing module that manages the cluster; a secure key creating module that creates a secure cluster key; and a share creating module for creating a share of the cluster key, wherein each of the plurality of nodes within the cluster stores a share of the cluster key. Each of the plurality of nodes in the cluster may contain a share creating module for creating a share of the cluster key.

The system may include a failover determining module that determines whether one of the plurality of nodes has failed and/or a function assigning module that assigns functions of one of the plurality of nodes to another one of the plurality of nodes.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 illustrates a cluster according to some embodiments of the invention.

FIG. 2 further illustrates a node of the cluster according to some embodiments of the invention.

FIG. 3 is a functional block diagram of a HAT agent according to some embodiments of the invention.

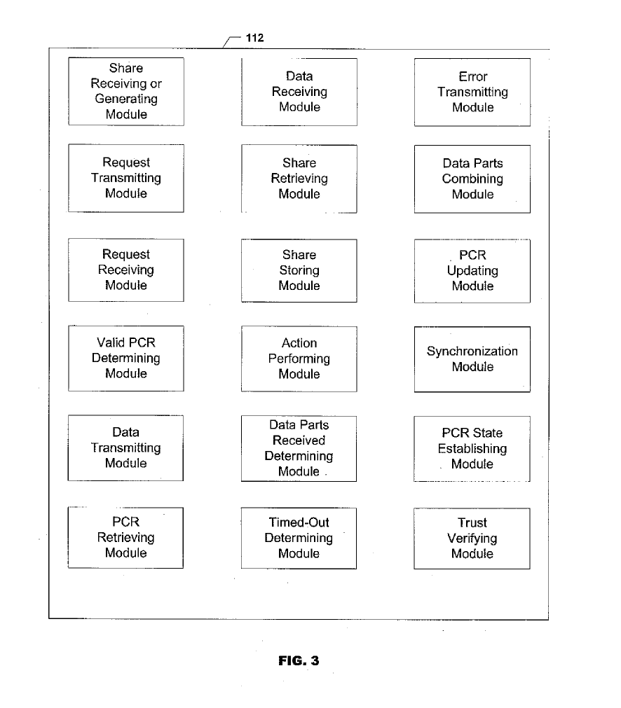

FIG. 4 is a functional block diagram of an availability manager according to some embodiments of the invention.

FIG. 5 is a flowchart illustrating a process according to an embodiment of the invention.

FIG. 6 is a flowchart illustrating a process according to an embodiment of the invention.

FIG. 7 is a flowchart illustrating a process according to an embodiment of the invention.

FIG. 8 is a data flow diagram illustrating a data flow according to an embodiment of the invention.

FIG. 9 is a flowchart illustrating a process according to an embodiment of the invention.

FIG. 10 is a flowchart illustrating a process according to an embodiment of the invention.

FIG. 11 is a flowchart illustrating a process according to an embodiment of the invention.

FIG. 12 is a flowchart illustrating a process according to an embodiment of the invention.

### DETAILED DESCRIPTION

Embodiments of the present invention provide processes and infrastructure that will allow the use of TPM functionalities in the context of a cluster (e.g., an HA cluster). The distinguishing feature of TPM functionalities is arguably the incorporation of ‘roots of trust’ into computer platforms. This notion is at odds with the nature of a cluster, which is a collection of nodes, thus a TPM is not natively designed to provide roots of trust into clusters.

Aspects of the present invention extend functionalities defined by the TCG specification to an entire cluster by creating a framework named ‘HAT,’ which stands for ‘High Availability TPM.’ Embodiments of the invention provide a root of trust (RoT) for a cluster. The cluster RoT (C-RoT) is distributed in all nodes and functional, provided that the cluster can resist the failure in (or of) a predetermined and configurable number of nodes in the cluster. The C-RoT for a cluster is rooted in TCG functionality at each node in the cluster. However, in some embodiments, each node in the cluster will maintain its own RoT rooted in its TPM, which is distinct from the C-RoT. Aspects of the invention also provide a framework to extend TCG functionalities to the cluster. We call these TCG functionalities available in the cluster, the cluster TCG operations.

Redundancy may be defined as the availability of resources and functionality of an active process (e.g., an active process running on node A) to the standby processes to ensure that should the active process fail, the standby processes can take over its function (say on node B). If any information requires TCG functionality on the node A, the HAT framework will ensure that the same TCG functionality is available for the standby process on node B. To illustrate the above, we provide a classical use case in HA server which HAT addresses. Process A on node X provides some service and is the active process. Process B on node Y is able to provide the same service and is the standby for the process A. Process A uses some TCG defined functionality for providing a service (e.g. Process A uses some key K for session encryption). Process A crashes. The HAT framework automatically switches over the service to process B. Process B must have access now to the TCG functionality provided on node X (e.g. access to key K for session encryption). HAT provides this functionality to process B.

Overview of HAT Functionality

1. HAT Cluster-Wide Trusted Operations:

In some embodiments, the invention supports all TCG operations at the cluster level. We call these operations ‘cluster TCG operations’ or ‘cluster operations.’ These cluster operations are transparent to TPM user applications. Some examples of cluster operations include: key creation and deletion, cluster-wide crypto operations (signing, sealing, binding using cluster-wide keys), and cluster-wide secure storage. These operations can be transparently executed in different nodes of the cluster. For example, a key K can be created on node 1 of the cluster to seal some data to some cluster PCR value (a cluster PCR value is a value representing a configuration of the cluster—the cluster PCR may be created by TCG functions, but implemented in HAT for the cluster). Later on, the data can be unsealed transparently by another process on node 2 without any need for applications on node 2 to explicitly retrieve the key K. In addition, the cluster PCR value can be used in node 2 to seal some data. The same can be applied for binding, signing, etc. This functionality can be advantageous, among other examples, in HA environments where there is a need for fast failovers from active processes to standby processes possibly on different nodes of the cluster. This functionality is also very useful for any clustered server when software components can move between different nodes for load or configuration reasons. It should be noted that not all functionality needs to be cluster-wide. For example, at least in some cases, there is may be no need to have a cluster-wide MD5 operation.

2. HAT Cluster Key

In some embodiments, the invention provides a HA threshold crypto implementation. To perform some crypto operations (e.g., unbinding, unsealing, signing at cluster level, etc.) there is a need for at least one cryptographic key. In order to perform crypto operations on a cluster-wide basis, there is need for each node to access that key. A simple solution is to store the key in one node and allow the other nodes access to the key. Such a solution is not HA compliant because the key access may become a bottleneck (this may be true for even mid-size clusters). An alternative can be to replicate the key on all nodes in the cluster. This solution has the major disadvantage of multiplying the risks of key compromise by the number of nodes in the cluster (i.e., for a cluster with n nodes the chances of a possible compromise are multiplied by ‘n’). To avoid the replication solution, in some embodiments of the invention, the HAT framework uses threshold crypto mechanisms. Currently TCG creates ‘normal’ public/private keys. Embodiments of the invention extend this functionality. For example, the HAT framework creates threshold public/private cluster keys. This means that nodes of the cluster store a share of the cluster private key and implement a procedure that computes the public key corresponding to their collective shares. Once the public key is computed, it should be made available (e.g., ‘published’) so, that, for instance, other entities could bind data to the cluster (i.e., encrypt data using the cluster's public key, which encrypted data can only be decrypted using the cluster's private key as represented by the collection of shares the nodes hold). The shares may be created locally at each node or remotely by a central entity ('dealer') and then provided to each node according to threshold cryptography. That is, a plurality of nodes in the cluster generate a share (or receive a share) of the cluster private key. This has the advantage, among other aspects, of being fault tolerant and more secure at cluster level. In the preferred embodiment, the cluster private key does not exist in the cluster, rather only shares of the private key exist in the cluster.

3. HAT Root of Trust

A TPM (a chip comprising a microcontroller and storage units) may store a key called an Endorsement Key (EK). The EK is used in a process for the issuance of credentials (e.g., Attestation Identity Key (AIK) credentials) and to establish a platform owner. The platform owner can create a storage root key. The storage root key in turn is used to wrap other TPM keys. Currently, the TCG specification uses the EK as the root key for rooting the trust in each node. HAT implements a key root of trust rooted in the entire cluster. We call this cluster key the ‘cluster endorsement key’ (C-EK). This cluster key is, in the best embodiment, based on threshold cryptography. By making the C-EK fault tolerant and more secure, this mitigates risks of loosing the C-EK or compromise. Upon initialization of HAT in a cluster, a threshold C-EK is created, which is shared among all nodes of the cluster. All cluster credentials may be generated from this C-EK. This provides a unique ID for the cluster which can be shared among different nodes and is valid while t nodes of the cluster are up and running (in a threshold scheme of (t,n)). Note that in the case of geographically distant sites, the same C-EK can be used for both sites in order to ensure a possible switchover from one site to the other. In this scenario, the cluster is extended to two sites.

4. Cluster Platform Configuration ‘Registers’

In some embodiments, the existing platform configuration registers (PCRs) are extended to a new cluster-wide configuration registers. The cluster platform configuration ‘registers’ are similar to normal TPM PCRs, they differ from normal PCRs in that they are defined at cluster level: they present the same value everywhere in the cluster and are not limited in numbers. Their value can depend on one or several nodes in the cluster. More details are described below.

HAT may be a completely software based framework. The trust on HAT is rooted in TCG Trusted Software Stack. But, parts of HAT functionality, especially HA Root of Trust, may be implemented as part of TPM Hardware or as new hardware components. By transitive trust, HAT components can be trusted given that underlying components (e.g., OS code, OS boot loader code, and CRTM code) have also applied transitive trust from the TPM.

### Technical Description of an Embodiment of the invention

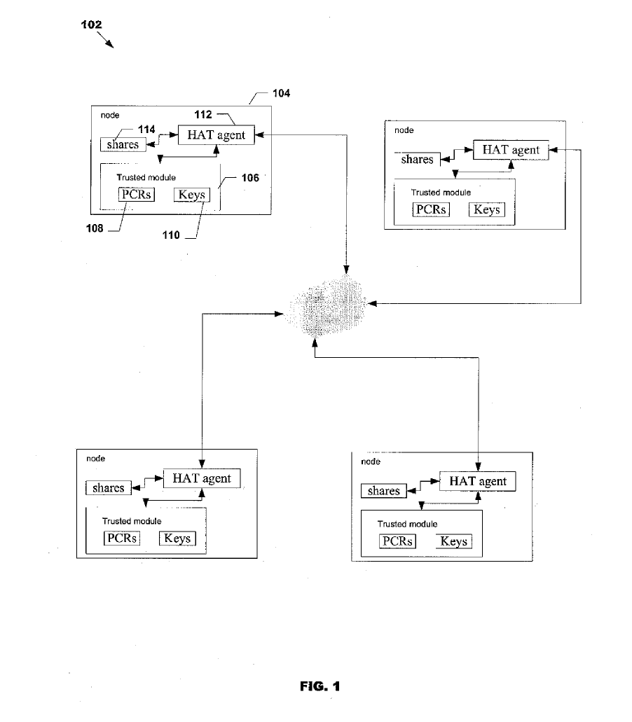

Referring now to FIG. 1, FIG. 1 illustrates an environment in which the HAT framework may be employed. More specifically, FIG. 1 illustrates an HA cluster 102. In the embodiment illustrated, HA cluster 102 includes four nodes (however the invention is not limited to any particular number of nodes), and each node 104 includes a trusted module 106 (e.g., a Trusted Platform Module (TPM)). As shown, each trusted module 106 may include a storage unit 108 (e.g., one or more platform configuration registers) for storing values representing a cluster configuration and/or a node configuration and a storage unit 110 (e.g., a non-volatile memory device) for storing one or more cryptographic keys. Aspects of the trusted module 106 may be implemented in hardware and/or software. In some embodiments, each trusted module 106 includes a microcontroller with cryptographic functionalities and storage units (e.g., non-volatile memory). Each node 104 also includes a HAT agent 112 and one or more shares 114.

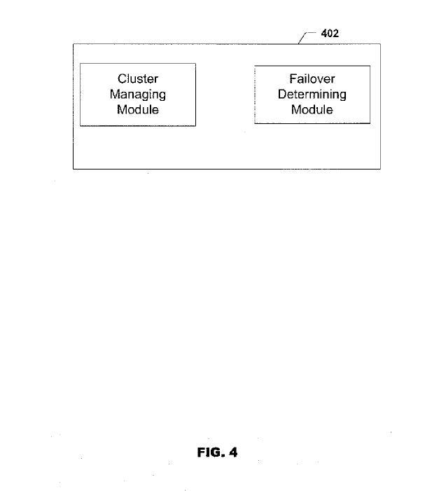

An availability manager 402 (see FIG. 4) may manage the availability of the cluster 102. A functional block diagram of availability manager 402 is illustrated in FIG. 4. As illustrated in FIG. 4, availability manager 402 may have one or more modules.

In some embodiments, the HAT framework needs only one service domain. A service domain is a set of processes grouped together to provide some service in a cluster. These processes can be in an active or standby state. Normally, switch-over or fail-over from a process in an active state to a process in a standby stat can happen only between processes in the same service domain. Therefore, with a HAT framework per service domain, TCG operations will be available after the switch-over or fail-over between different processes. In some embodiments, the HAT framework must include all standby processes of the active processes in the service domain, otherwise processes that fail-over cannot access the TCG functionality accessible by the active process, and therefore this can lead to incapacity of the standby process to provide the service. There may be several HAT infrastructures running inside the same cluster and these HAT infrastructures may overlap with each other. As long as the different HAT components are isolated from each other, there is no interference.

For the sake of brevity, in the following descriptions we shall assume that cluster 102 is dedicated to only one HA application running in one service domain extending to all nodes of the cluster. Therefore, there is no difference between a cluster and a service domain.

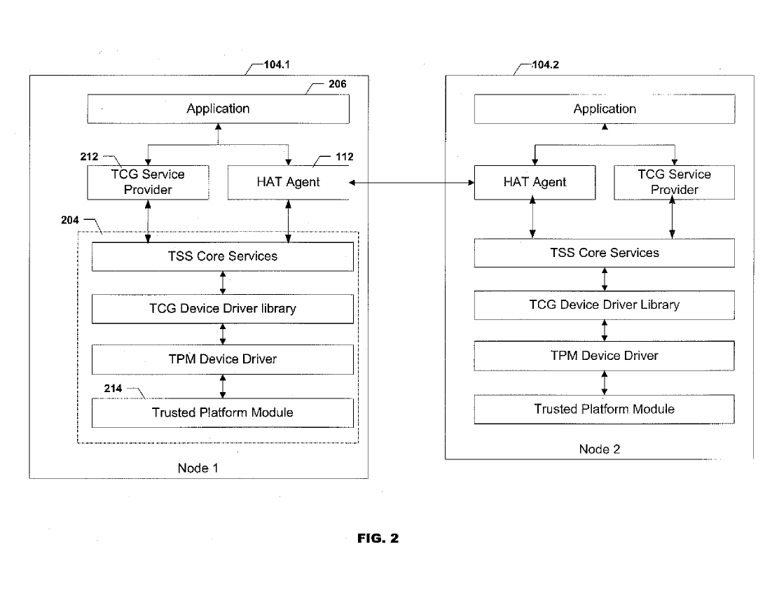

In some embodiments, the HAT framework is a fully distributed framework comprising local interface modules (a.k.a., HAT agents—which may be implemented in hardware and/or software) on each node of the cluster. This feature is illustrated in FIG. 2, which shows further details of two nodes of cluster 102.

As illustrated in FIG. 2, each HAT agent 112 may be part of or make use of a TCG software stack 204 on each node. Therefore, the trust in a HAT agent, and subsequently a HAT framework itself, is rooted in TCG implementations in each node. A HAT agent 112 may be responsible for coordinating with all other HAT agents 112 to complete cluster cryptographic operations (a.k.a., ‘cluster TPM operations’). A cluster TPM operation is defined as a security operation (a.k.a., cryptographic operation) that is performed on all cluster nodes or some threshold subset of cluster nodes. If a node fails to perform certain TPM cluster operations, it may eventually re-synchronize with the other nodes by, for example, means of an automatic procedure when rejoining the cluster. For example, the need for synchronization may only be present when creating information such as a cluster key or sealed data. That is, there is no consequence if a node fails to, for example, unseal the data provided that at least a threshold number of nodes did not fail. Also, in the special case of creating a cluster key, it may be mandatory in some embodiments for every node to participate and obtain its share.

In some embodiments, re-synchronization of secret shares in the cluster is done by regenerating them in all nodes of the cluster. Note that this regeneration is done without materializing the HA RoT private key in any server. This can be done through the proactive secret sharing protocols (e.g. [APSS]). This re-synchronization maximizes the availability of the keys in the cluster. For example, in the scenario when not all the nodes have participated at the creation of a key, after the synchronization the non-participating nodes will have a share of the key. This way, if some of the nodes participating in the creation will fail the key is still available.

As further shown, a HAT agent 112 can communicate with other HAT agents in the cluster through a network. Accordingly, in some embodiments, each agent 112 is configured with the node addresses of all nodes in the cluster to communicate with remote agents. In Service Availability parlance, the service providing this functionality is called Cluster membership service. Communications between two agents 112 should be secured using a security protocol (e.g. re-use the protocols defined by TCG that support command validation, namely OIAP and OSAP or independent security protocols like IPSec etc).

As further shown in FIG. 2, each HAT agent 112 resides in user space. In some embodiments, when a HAT agent 112 receives from another HAT agent a request to perform an operation, it proceeds with execution of the operation by using stack 204. Any return values expected by the requesting HAT agent would be sent by the executing HAT agent over the network in a secure way. Preferably, each application 206 uses cluster TCG operations when the application needs to implement HA operations which involve use of stack 204. This allows, for instance, the HA operations to be transferable in the cluster in the case of a switch-over or fail-over operation.

In some embodiment, the invention provides applications 206 in the cluster with a new application programming interface (API) called ‘cluster TCG API’. The cluster TCG API provides similar functionalities as the well known TCG API, with the exception that the operations provided by the cluster TCG API are extended to the entire cluster. Any application 206 which needs to use TCG functionality and needs HA support should use the cluster TCG API in order to provide the application the ability of moving service from a process to another process in the cluster without losing TCG functionality leading to possible service interruption. In some embodiments, the cluster TCG API interface is an extension of the TCG Service Provider Interface (TSPI).

For each area, ‘cluster’ methods are defined analogous to the local TSP method with the added functionality of communicating both the information and the operation with the redundant HAT agents which reside on other nodes of the cluster. As a result, the HAT agents will replicate the operations across the cluster. The HAT extension to the TSPI (TSP Interface) is visible to applications and should be used explicitly for cluster-wide TPM operations. These operations can be transparently used by all user applications in the cluster (e.g. a key created on node 11 can be used transparently on node 5).

The TSP command extensions (‘cluster commands’) exhibit the same behavior, namely to send a request to the local HAT agent to replicate the command on all nodes in the cluster including the local node. Then, the HAT agent is responsible for executing the required function locally and requesting the remote HAT agents to acknowledge completion of the same command remotely.

Some cluster commands must be blocking. In other words, no other cluster commands should occur while the blocking command is being executed by all HAT agents in the cluster. Therefore, the HAT agent that is executing the command must, in those specific cases, first establish a blocking condition with all other HAT agents before proceeding. Upon completion of all commands, successful or not, the blocking condition is removed by the original HAT agent.

In some embodiments, all cluster commands must be acknowledged by remote HAT agents to the local HAT agent who initiated the blocking cluster command upon completion, indicating a failure or a success. This will preserve integrity in the cluster HAT agents' information.

When blocking communication occurs between HAT agents, a timeout may be implemented to avoid indefinite delays due to hardware crashes or other potential failures in communication. In the event of timeout, the blocking command can be assumed to have failed for the HAT agent that failed to respond.

When an application performs a cluster TPM operation, it may execute the call through the TSPi. Subsequently, the local HAT agent is responsible for executing the equivalent call locally as well as coordinating execution of the call on all other HAT agents in the cluster.

TPM Cluster Operations:

(1) Ownership Commands:

The owner of a TPM has the right to perform special operations. The process of obtaining ownership is the procedure whereby the owner inserts a shared secret into the TPM. For all future operations, knowledge of the shared secret is proof of Ownership. Upon HAT initialization in a cluster, a pass phrase is set by a cluster administrator to take ownership. Every time a node is added to the HAT framework, the administrator must locally take ownership by setting the pass phrase to initialize HAT. This way, the knowledge of pass phrase is used to authorize access to HAT in different nodes of the cluster. However, every time a node is added, the C-EK must be re-synchronized as the cluster has changed, thus, the pass phrase may be necessary to add a node, but it is not sufficient. A success code is returned indicating that the pass phrase is valid and the node can support TPM cluster operations. An error can be generated for invalid pass phrase, absence of HAT agent or an error in HAT implementations etc.

(2) Integrity Measurement and Reporting:

A cluster configuration value(s) is used for TPM cluster integrity measurement and reporting.

(3) Seal/Unseal:

A cluster configuration value(s) can be used for cluster sealing and unsealing. Sealing takes the cluster configuration values (or ‘cluster PCR values’) and a set or subset of required future PCR values as input to the operation. Correspondingly, the unseal operation returns the unsealed data and also the cluster PCR values at the time of sealing.

(4) Identity Creation and Activation:

This functionality generates a new AIK based on a cluster EK, called cluster AIK. The cluster AIK shares are distributed in all nodes. Any HAT agent can ask for the creation of cluster AIKs. The AIK is then created by all HAT agents. It is mandatory for all nodes to be involved in this process.

(5) Authorization Sessions:

This functionality generates a nonce for each command and asks a new hash to be sent at each command request. Its goal is to keep track of authorizations for a session. HAT should store the hash sent back by TPM for each session in the standby node. Upon requests for the session handle in the standby node, HAT should provide this nonce to the requestor in the standby node. Therefore, a new API can be added to provide the nonce in the standby node for a determined session.

(6) Session Management:

This functionality saves the context for a session and allows its restoration. These sessions are used with delegation. Different contexts upon creation should be exported to the standby node in order to prepare for a switch-over between the active and the standby nodes. This function applies more particularly to switch-over scenarios. The active process saves its context, sends it to the standby process. The standby process should be able to retrieve the session and follow up.

(7) Transport Sessions:

This functionality is used to transmit a command to TPM. The transport sessions can be saved and restored. The saved transport sessions should be sent, for instance, to all nodes in the cluster to be used in case of switch-over, if implemented, as it would create a heavy processing requirement on the cluster.

(8) Direct Anonymous Attestation (DAA):

This functionality requires the interactions between TCG and a third party issuer. In this case, the issuer should collaborate to provide the same DAA to two different nodes.

(9) Non-Volatile Storage:

Storage commands define areas where a TPM owner can write and read from. It is possible that for writes in some locations there is need for authorization. In this case the authorization values should be provided in any node in the cluster. HAT extends the same functionality for TPM cluster storage.

Cluster PCR

As discussed briefly above, for each node in the cluster, there may be a cluster configuration value recorded in the node's TPM's platform configuration register (PCR), or elsewhere, for use in TPM operations (e.g., sealing and binding). A storage unit that holds a cluster configuration value is referred to as a cluster PCR. Each HAT agent defines at least a common set of cluster PCRs maintained locally through protected storage or within a reserved set of TPM PCRs.

A cluster PCR value is a value that is consistent across at least certain nodes of a cluster. The cluster PCR value(s) reflect a state or configuration of the cluster. A possible implementation could be software PCRs located in and maintained by the HAT agents on each node. Alternatively, cluster PCRs could also consist of the same PCRs within each local TPM reserved for use by HAT agents. Other implementation of cluster PCRs are also possible.

Preferably, any update to a cluster PCR is done on all nodes in one atomic (or blocking) operation with respect to any other TPM operation to preserve integrity and prevent race conditions. Note that these cluster PCRs are, in some embodiments, completely distinct from the local PCRs. The local PCRs are used for local TPM operations.

An example of a cluster PCR value is a value derived from a PCR value stored in each node of the cluster. This cluster PCR value then comes to define that all nodes in the cluster run secure operating systems. The cluster PCR allows the use of sealing based on a cluster configuration value and at the same time the switch-over between different nodes in the cluster.

It is also possible that an application decides for some security reasons to seal data based on a PCR value stored in a remote node. This applies to the cases where the availability system prepares for a switch-over between 2 processes and wants the active process to explicitly encrypt data to be sent over to a defined node. The active process, by sealing using a defined PCR, puts a condition on the switch-over to the PCR on that node, i.e. accepts the switch-over of secure data depending on some integrity measures on the standby node. In this case, we define cluster PCR as <NID><Role><PCR Selection>. Even though the Node PCR value is known in the entire cluster, only the node receiving the data can unseal the data when it got right PCR value (secure configuration).

HA TPM Scenario

Having defined the HAT agent, we turn to its application in realizing a High Availability cluster with High Availability TPM architecture. A concept in high availability systems is redundancy and fast failover. With a local TPM providing a local root of trust and trusted computing for a node of a cluster, the HAT agent will be the enabler of a cluster-wide root of trust.

First, we define a threshold number of nodes to be used in threshold cryptography for the cluster (the generation of the shared secret and its safe distribution to all nodes is assumed). For example, a cluster of three nodes may choose a threshold of two nodes. This means that for any cluster TPM operation to be successful, at least two nodes must participate.

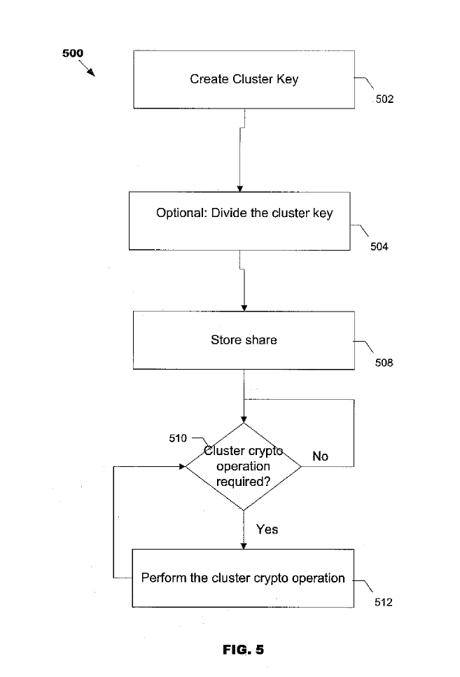

Referring now to FIG. 5, FIG. 5 is a flowchart illustrating a process 500, according to some embodiments, of cluster key usage within a high-availability cluster. Process 500 may begin in step 502 where a processor or other device centrally creates a cluster key. Alternatively, the cluster key creation step 502 may be performed as a distributed task during which each node generates its share of the key. If the key is created centrally, the step 502 may be performed by a cluster manager (which may or not be one of the nodes in the cluster). In the central-creation scenario, after the cluster key is created, it is divided into a plurality of shares, each being transmitted to one of the plurality of nodes within the cluster such that each node receives one share (504). Step 504 is performed only if the key is created centrally and not if key creation is distributed and it is, thus, an optional step. In step 508, after generating the share (or receiving the share as the case may be), each of the nodes stores the share. Preferably, each node stores the share locally to, for example, a memory device (e.g., in a storage unit of a TPM). Alternatively, the share may be stored in a remote location.

A determination is made in step 510 to determine whether a cluster cryptographic operation is required (e.g., requested from, for example, an application). This determination may be made, for example, by receiving a request for an operation to be performed on select data. The request may include the data on which the operation is to be performed and an identification of the operation to be performed.

If an operation is determined to be required, then process 500 may proceed to step 512. Otherwise, process 500 may return to step 510.

In step 512, the operation is performed on the data. The operation may be, for example, sealing data, unsealing data, binding data, unbinding data, and signing data. Step 512 includes retrieving a share that is stored locally to the node that received the request and/or transmitting a request to at least a threshold number of other nodes. After step 512, the process returns to step 510.

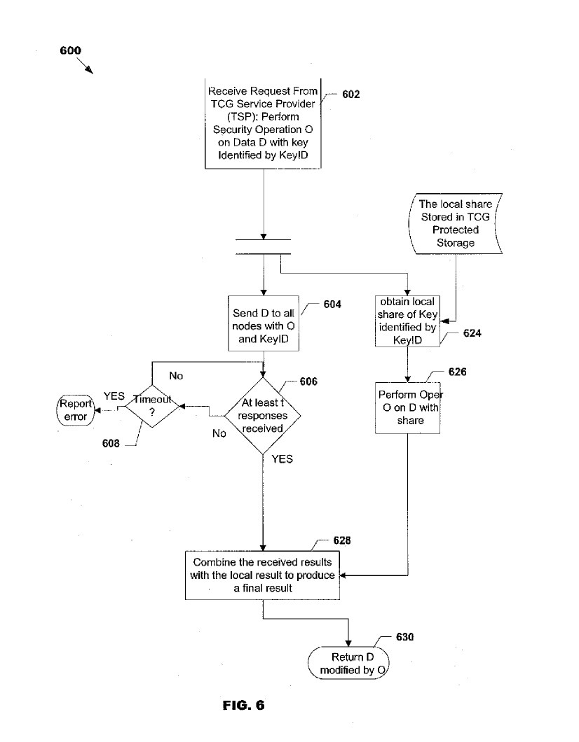

Referring now to FIG. 6, FIG. 6 is a flowchart further illustrating a process 600 for performing a cluster cryptographic operation (or ‘cluster TPM operation’). The process may begin in step 602, where a HAT agent 112 executing on a node of a cluster receives a request to perform a cryptographic operation (e.g., a security operation). The request may be received from a TCG service provider 212, which received the request from an application 206. The request may include an operation identifier identifying the cryptographic operation to be performed, data (or a data identifier identifying data) on which to perform the operation, and a cluster key identifier identifying a cluster key. After step 602 the agent 112 may perform steps 604 and 624.

In step 604, the agent 112 transmits a request to each of plurality of other agents executing on other nodes of the cluster. This request may include the operation identifier identifying the cryptographic operation, the data (or the data identifier), and the cluster key identifier identifying the cluster key. In step 606, agent 112 determines whether at least a threshold number of responses to the request have been received. If so, the process proceeds to step 628, otherwise it proceeds to step 608. In step 608, agent 112 determines whether a time-out condition has occurred (e.g., agent 112 determines whether a certain amount of time (e.g., 2 seconds) has elapsed since the requests were sent). If a time-out condition occurs, an error may be reported, otherwise the process goes back to step 606.

As shown on FIG. 6, steps 604-608 and 624-626 can be executed in parallel, but the actual ordering of these steps has no material affect on the invention. In step 624, the agent 112 retrieves a share of the cluster key identified by the cluster key identifier. The share may be stored in a TPM in the node on which the agent executes or in some other protected storage. The share may also be encrypted. Thus, the step of retrieving the share may include decrypting the encrypted version of the share to obtain the share. In step 626, after the share is obtained, the agent uses the share to perform the operation on the data, thereby producing a local partial result of the operation. The step of using the share to perform the partial operation may include using some of or the entire stack 204 to perform the operation (e.g., using the TPM 214).

In step 628, assuming no time-out condition and that step 626 executed without error, the agent, using conventional threshold cryptography, combines the partial results received from each of the other agents with the local partial result to produce a final, complete result (e.g., the data modified according to the identified crypto operation). It should also be mentioned that steps 624-626 can, be completely skipped, e.g., based on the local condition, explicit request or configuration. In such a case, the threshold number of partial results is fulfilled only from other nodes and the step 628 is limited to combining the partial results received therefrom. In step 630, the agent returns the final, complete result to the entity (e.g., service provider 212 or application 206) that requested the operation.

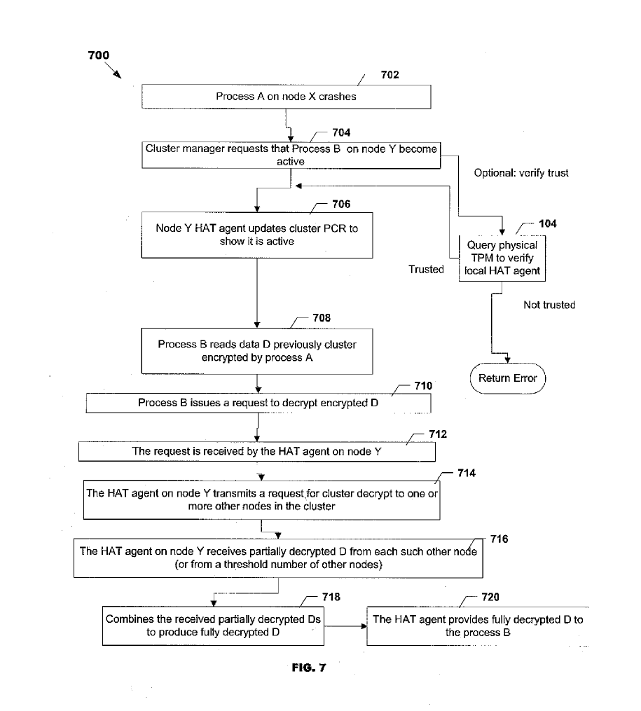

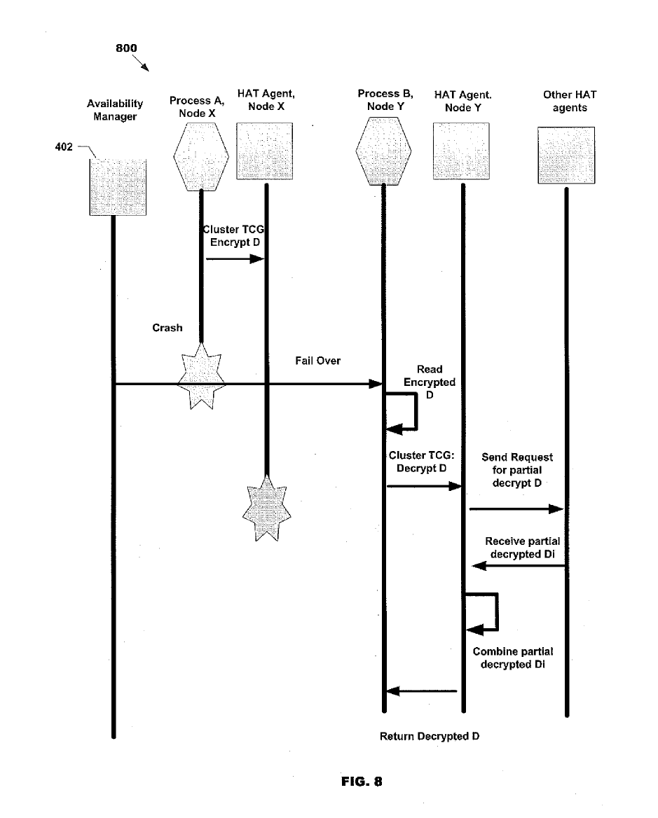

Referring now to FIG. 7, FIG. 7 is a flowchart illustrating a fail-over process 700 according to some embodiments. This process is further illustrated in the data flow diagram 800 shown in FIG. 8. The process may begin in step 702, where a process A running on node X crashes. Prior to the crash, process A encrypted data D using its local HAT agent (e.g., process A performed a cluster encrypt of data D). In step 704, the availability manager 402 requests that process B on node Y take over for process A. Optionally, the HAT agent on node Y is verified as being trusted using a TPM on node Y (step 705).

In step 706, the HAT agent on node Y updates a cluster PCR value to show that it is now an active node in the cluster. In step 708, process B reads the encrypted data D. In step 710, process B issues a request (e.g., calls a function) to decrypt the encrypted D. In step 712, this request is received by the HAT agent on node Y. This agent transmits a request for a cluster decrypt to one or more other nodes in the cluster (step 714). This request message may include the encrypted data D, a cluster key identifier, and an operation identifier that identifies the decrypt operation. In step 716, assuming no time-out condition occurs, the agent on node Y receives partially decrypted D from each such other node. Next, the agent combines the data received from the other nodes to produce fully decrypted D (step 718). In step 718, the received data may be combined with a locally generated partial decrypt of D. In step 720, the agent provides the fully decrypted D to process B.

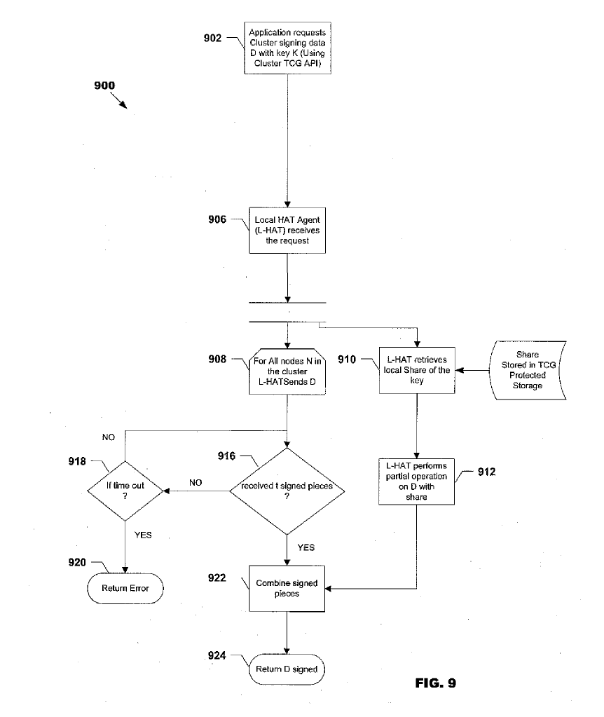

Referring now to FIG. 9, FIG. 9 is a flowchart illustrating a process 900, according to some embodiments, for signing data using a cluster key. Process 900 may begin in step 902, where an application of a requesting node within a cluster (e.g., an HA cluster) requests that data D be signed using a cluster key. The application may provide the request to a Trusted Computing Group (TCG) Service Provider (TSP) of the requesting node by calling a particular API function. The request may include data D (or information identifying data D) and an identifier that identifies the cluster key.

In step 904, the request is received by the TSP and forwarded to an HAT agent of the requesting node. Next (step 906), the local HAT agent receives the request. The local HAT agent then transmits the request to all nodes N within the high-availability cluster (step 908). The request may include the data D or an identifier that identifies the data D. The request may also include a cluster key identifier.

In step 910, the local HAT agent retrieves a stored share of the cluster key. According to one embodiment, the share is stored in TCG protected storage. In step 912, the local HAT agent performs a partial signature on data D using the share. The local HAT agent may only perform a partial signature because the share constitutes only one part of the cluster key K. Partial signatures must be performed by at least a quorum of nodes having a share of cluster key K. As described below, if the local HAT agent receives at least the threshold number of partial signatures, the local HAT agent can combine the partial signatures to produce a full signature on data D.

In step 916, a determination is made regarding whether the at least a threshold number (t) of responses have been received. If at least t responses have not been received, then a time-out determination is made (step 918). If a time-out has occurred, then an error may be returned (step 920). If a timeout has not occurred, the process may proceed back to step 916. If at least t responses have been received, then the agent combines the responses with the result from step 912 to create the signed data (step 922). The signed data may then be returned (step 924).

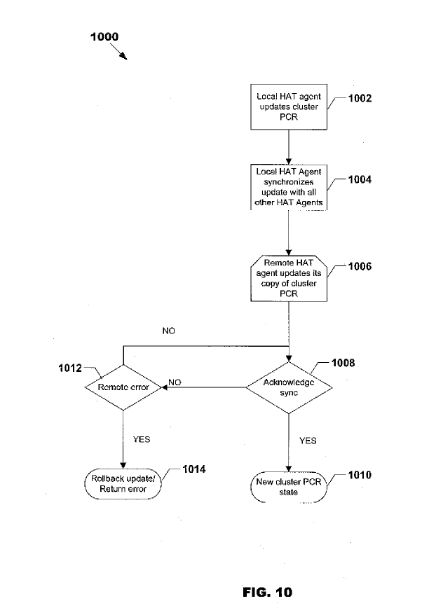

Referring now to FIG. 10, FIG. 10 is a flowchart that illustrates a process 1000 of using a cluster configuration value. Process 1000 may begin in step 1002, where a local HAT agent of a node within a cluster updates a cluster PCR (e.g., changes the value stored in a predefined PCR of a TPM). Next (step 1004), the local HAT agent synchronizes the update with each HAT agent of each node within the cluster. Each node HAT agent then updates its copy of the cluster PCR in step 1006 based on the update cluster PCR of the local HAT agent.

In step 1008, a determination is made regarding whether a synchronization acknowledgement has been received from each node to which the update was sent. If a determination that a synchronization acknowledgement has been received, process 1000 may proceed to step 1010. In step 1010, a new cluster PCR state may be identified.

If a determination is made in step 1008 that a synchronization acknowledgement has not been received, a determination may be made in step 1012 regarding whether an error with a remote node exists. If a determination is made that an error does not exist, process 1000 may return to step 1008. Otherwise, if a determination is made that an error does exist, a rollback update and/or error message may be transmitted.

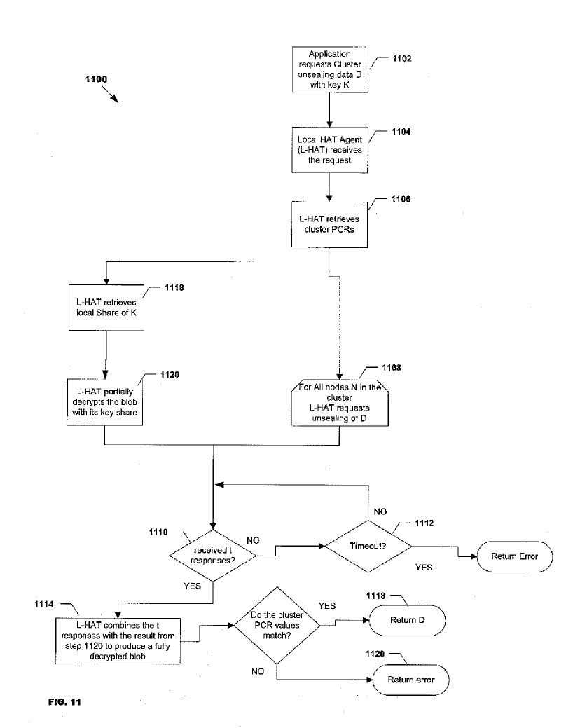

Referring now to FIG. 11, FIG. 11 is a flowchart illustrating a process 1100 for cluster unsealing data D. The process may begin in step 1102, where an application on a node of the cluster requests cluster unsealing of data D with key K. In step 1104, the local HAT agent (‘L-HAT agent’ or ‘agent’) on the node receives the request. In step 1106, the agent obtains the cluster PCR value (or values) to which the data D was presumably sealed. In step 1108, the agent sends a cluster unseal request to each of N nodes in the cluster. The request may contain or identify a blob containing the data D and the cluster PCR value(s) to which D was sealed (e.g., the PCR value(s) could be the complete set of PCR values at the time of sealing and a required subset (possibly the full set) of PCR values that needs to be matched at the time of unsealing). The request may also contain a key identifier identifying a key K. In step 1118 (which may be performed in parallel with step 1108), the agent retrieves a share of key K, which share may be stored in a TPM in the node in which the agent operates. In step 1120, the agent performs a partial decryption of the blob using the share obtained in step 1118 to produce a partial local result. In step 1110, the agent determines whether it has received at least a threshold (t) number of responses to the request sent in step 1108. If t number of response has not been received, then the agent determines whether a time-out condition has occurred (e.g., the agent determines whether at least x amount of time has passed since step 1108 was performed) (step 1112). If a time out condition has occurred, the process may end with an error condition, otherwise the process proceeds back to step 1110. If the agent has received at least t responses, then in step 1114 the agent, using conventional threshold cryptography, combines the responses with the partial local result to produce a fully decrypted blob. In step 1116, the expected cluster PCR value(s) contained in the decrypted blob is/are compared with the cluster PCR value(s) obtained in step 1106 to see if there is a match. If the cluster PCR value(s) from the decrypted blob match the cluster PCR value(s) obtained in step 1106, then the agent returns D and, for security reasons, potentially the complete set of PCR values at the time of sealing (step 1118), otherwise an error is returned (step 1120).

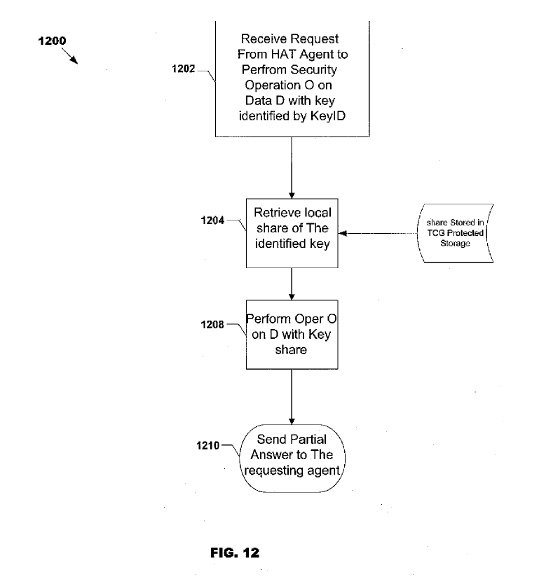

Referring now to FIG. 12, FIG. 12 is a flowchart that illustrates a process 1200 performed by a HAT agent that receives a request sent from another HAT agent. Process 1200 may begin at step 1112. In step 1112, an operation request from a remote HAT agent is received at a local HAT agent. The operation request may be, for example, to perform a security operation O on data D using the key identified by KeyID. The security operation O may be signing, binding, unbinding, sealing or unsealing the data D (or other operation).

After receiving the request, in step 1204, the local HAT agent obtains a local share of the key identified by KeyID. The local share may be stored in a TCG protected storage (e.g., a storage unit of a TCG TPM).

In step 1208, the local share is used to perform the operation O on data D to produce a partial result. The operation creates a partial answer of the request. This is because each HAT agent has access to its share of the cluster key. Therefore, each HAT agent creates only a partial answer to the requested operation. After performing the operation, the local HAT agent transmits a response (i.e., the partial result) to the remote HAT agent (step 1210). As discussed above, the remote HAT agent that issued the request may combine the partial result produced in step 1208 with other partial results produced by other HAT agents to produce a full result.

The HAT framework described herein has several advantages, some of which are identified in the present application, others will be apparent to those of ordinary skill in the art. For example, the framework enables TCG functionality anywhere in the cluster. It also enables a fault tolerant, secure root of trust distributed in the cluster. Additionally, it enables a cluster in which the active and standby processes do not need to perform any particular operations other than normal TCG operations to ensure accessibility and reliability of these operations in the cluster (e.g., they are available as long as t nodes among n nodes of the cluster are functional). Thus, it may allow transparent HA support for cryptographic operations between active and standby processes on different nodes after switch-over.

While various embodiments of the present invention have been described above, it should be understood that they have been presented by way of example only, and not limitation. Thus, the breadth and scope of the present invention should not be limited by any of the above-described exemplary embodiments. More particularly, a person skilled in the art will readily appreciate that the present invention is not limited to the TCG's TPM in its current or future form, but is capable of being adapted to various existing or upcoming trusted module solutions.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

1. In an environment comprising a cluster of nodes, a method of performing a security operation on data D, wherein each of a plurality of nodes in the cluster contains a share of a cluster key, comprising:
requesting from a first node that each of the plurality of nodes in the cluster perform a part of the security operation on D;
receiving, from each of at least a threshold number of nodes from said plurality of nodes, a partial result of the security operation;
obtaining a local share of the cluster key using a trusted platform module (TPM) in the first node;
using the obtained local share of the cluster key to perform a local part of the security operation on D, thereby producing a local result; and
combining the local result with the received partial results to produce a final result.

2. The method of claim 1, wherein the step of obtaining the local share comprises using TPM software to obtain the local share from a storage unit in the TPM.

3. The method of claim 1, wherein the step of obtaining the share comprises retrieving an encrypted version of the share and decrypting the encrypted version of the share to retrieve the share.

4. The method of claim 3, wherein the step of decrypting the share comprises using the TPM to decrypt the share.

5. The method of claim 1, wherein the TPM comprises a microcontroller with cryptographic functionalities.

6. The method of claim 1, wherein the security operation comprises any one of binding data, unbinding data, sealing data, unsealing data, and signing data.

7. The method of claim 1, further comprising the step of receiving from an application executing on the first node a request to perform the security operation on data D using the cluster key, wherein the step of receiving the request from the application occurs prior to the step of requesting from the first node that each of the plurality of nodes in the cluster perform a part of the security operation on D.

8. The method of claim 1, wherein the step of requesting from the first node that each of the plurality of nodes in the cluster perform a part of the security operation on D comprises sending from the first node to each of the plurality of nodes in the cluster the data D.

9. The method of claim 1, wherein each of the plurality of nodes in the cluster is configured to perform the part of the security operation on D by utilizing a TPM installed in the node.

10. A method of enabling trusted platform module functionality to a cluster comprising a set of nodes, wherein each node comprises an agent, a trusted platform module (TPM) chip and TPM software for accessing functions of the TPM, comprising:
creating a cluster key; and
storing in each node included in the set of nodes a share of the cluster key, wherein
the agent is operable to receive an application request, and is configured to (1) use at least some of the TPM software in response to receiving the application request and (2) transmit a request to a plurality of other agents in response to receiving the request.

11. The method of claim 10, further comprising, for each node in the set, storing the share provided to the node in the TPM.

12. The method of claim 10, further comprising, for each node in the set, encrypting the share provided to the node using the TPM and TPM software.

13. The method of claim 10, wherein the TPM software comprises a TPM device driver, a device driver library, a core services, and a service provider.

14. The method of claim 13, wherein the agent receives the application request directly from an application or from the service provider.

15. The method of claim 10, wherein the TPM comprises a microcontroller with cryptographic functionalities.

16. The method of claim 10, wherein the request is a request to perform a security operation using data.

17. The method of claim 16, wherein the security operation comprises any one of binding the data, unbinding the data, sealing the data, unsealing the data, and signing the data.

18. The method of claim 10, wherein the application request is a request to sign data and the agent is further configured to:
sending the data to each of a plurality of nodes in the cluster and requesting that each said node sign the data using a part of the cluster key;
receiving, from each of said plurality of nodes, a result of the performed security operation;
obtaining a share of the cluster key;
using the obtained share of the cluster key to sign the data, thereby producing a local result; and
combining the local result with the received results to produce a final result.

19. The method of claim 10, wherein each node included in the set of nodes generates a share of the cluster key.

20. The method of claim 10, further comprising transmitting a share of the cluster key to each node in the set of nodes.

21. A method of sealing data to a configuration of a cluster comprising a set of two or more nodes, comprising:
storing a cluster configuration value in each node included in the set;
using an agent executing on one of the nodes in the set to modify the cluster configuration value, wherein the modified cluster configuration value represents a particular configuration of the cluster; and
transmitting, from said agent to a plurality of other agents, each of which executes on a different one of the nodes in the set, the modified cluster configuration value, wherein
the agent uses the modified cluster configuration value and a share of a cluster key to seal the data to the particular cluster configuration.

22. The method of claim 21, further comprising providing to each node in the set a share of the cluster key.

23. The method of claim 21, wherein the cluster key was generated by a process executing on said one of the nodes in the set.

24. The method of claim 21, wherein each node in the set comprises a trusted platform module (TPM) and TPM software for accessing functions of the TPM.

25. The method of claim 21, wherein the step of using the modified cluster configuration value and a share of a cluster key to seal data to the particular cluster configuration comprises: (1) transmitting a message from the agent to the plurality of other agents, the message comprising the data and requesting that each of the plurality of other agents perform a security operation on the data; (2) receiving from each of the plurality of other agents a result of the security operation; (3) obtaining a share of the cluster key; (4) using the obtained share of the cluster key and the particular cluster configuration value to perform a security operation on the data, thereby producing a local result; and (5) combining the local result with the received results.

26. A cluster comprising a plurality of nodes, wherein each of said plurality of nodes comprises:
a trusted platform module (TPM);
TPM software for accessing functions of the TPM;
a share of a cluster key; and
an agent operable to receive a request to perform an operation, wherein the agent is configured to perform steps (1) and (2) in response to receiving the request to perform the operation:
(1) performing the operation using the TPM software; and
(2) transmitting to a plurality of other agents a request to perform the operation, wherein each other agent resides on a different one of the plurality of nodes.

27. The cluster of claim 26, wherein each of said plurality of nodes further comprises a storage unit storing a cluster configuration value representing a particular configuration of the cluster, wherein the cluster configuration value is used to seal data to the particular cluster configuration.

28. An agent for extending trusted platform module functionality to a plurality of nodes in a cluster, comprising:
a receiving module for receiving a request sent from an application to perform a security operation;
a module for using TPM software and a share of a cluster key to perform the security operation, thereby producing a local result, in response to receiving the application request to perform the security operation;
a transmit module for transmitting to a plurality of other agents a request to perform the security operation in response to receiving the application request to perform the security operation;
a result receiving module for receiving from each of the plurality of other agents a result of the security operation; and
a combining module for combining the received results with the local result to produce a final result.

29. The agent of claim 28, further comprising a share retrieving module that retrieves the share.

30. The agent of claim 28, further comprising a share storing module that stores the share.

31. The agent of claim 28, further comprising a valid cluster configuration determining module that determines whether a cluster configuration value is valid.

32. The agent of claim 28, further comprising a cluster configuration value retrieving module that retrieves a cluster configuration value.

33. The agent of claim 28, further comprising a timed-out determining module that determines whether an operation has timed-out.

34. The agent of claim 28, further comprising a cluster configuration value updating module that updates a cluster configuration value.

35. A system for extending trusted platform module functionality to a plurality of nodes in a cluster, comprising:
a plurality of nodes within a cluster;
a cluster managing module that manages the cluster;
a secure key creating module that creates a secure cluster key; and
a share creating module for creating a share of the cluster key, wherein each of the plurality of nodes within the cluster stores a share of the cluster key.

36. The system of claim 35, further comprising a share transmitting module for transmitting a share of the cluster key to each of the nodes within the cluster.

37. The system of claim 35, wherein each of the plurality of nodes in the cluster contains a share creating module for creating a share of the cluster key.

38. The system of claim 35, further comprising a failover determining module that determines whether one of the plurality of nodes has failed.

39. The system of claim 35, further comprising a mode request transmitting module that transmits a mode request to one of the plurality of nodes within the cluster.

40. The system of claim 35, further comprising a function assigning module that assigns functions of one of the plurality of nodes to another one of the plurality of nodes.
